(19) United States
(12) Patent Application Publication
(10) Pub. No.: US 2018/0349999 A1
(43) Pub. Date: Dec. 6, 2018

(54) SYSTEMS AND METHODS FOR GENERATING A GRAPHICAL USER INTERFACE DISPLAYING PARENT ORDER DATA

(71) Applicant: Nasdaq Technology AB, Stockholm (SE)

(72) Inventors: Peter BRANDON, Frenchs Forest (AU); Michael O'BRIEN, London (GB); Linh Duy LE, Fairfield (AU)

(21) Appl. No.: 15/994,731

(22) Filed: May 31, 2018

Related U.S. Application Data
(60) Provisional application No. 62/514,409, filed on Jun. 2, 2017.

(51) Int. Cl. G06Q 40/04; G06F 17/30; G06F 17/27; G06F 3/0482

(52) U.S. Cl. CPC G06Q 40/04; G06F 3/0482; G06F 17/2705; G06F 17/30604

(57) ABSTRACT

The technology relates to systems and methods for generating a graphical user interface that can visually depict a relationship between a variety of parent orders and their associated child orders. The technology parses a plurality of order data and stores the parsed in a database. When generating the user interface, the system can display the plurality of individual orders in the user interface while showing the associated “parent” orders for each order. The user interface can be modified by selecting at least one or more parent orders in which the associated child orders will be highlighted.

### RELATED APPLICATION

This application claims the benefit of priority of U.S. Provisional Application No. 62/514,409 filed Jun. 2, 2017, the entire content of which is incorporated herein by reference.

### TECHNICAL OVERVIEW

The technology described herein relates to a graphical user interface. In particular, the technology described herein relates to generating a user interface that can display objects indicative of parent orders and their associated child orders.

### INTRODUCTION

Technology is available for displaying data for markets (such as financial markets) using a graphical user interface. For example, certain visualizations are available that show orders and/or trades (e.g., of financial instruments) by plotting such activity on a graph. The position of an order/trade on the graph can be indicative of the value of the order/trade and the time the order/trade was entered/executed.

While many advances in this domain have been achieved over the years, it will be appreciated that new and improved techniques, systems, and processes in this domain are continually sought after.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### SUMMARY

The technology described herein addresses the problems in conventional technology, in part, by providing a system capable of generating a graphical user interface that visually displays parent order data along with the associated child order data. For example, the technology relates to a graphical user interface that displays a graph showing objects representative of parent orders and additional objects representative of child orders.

The technology parses a plurality of order data and stores the parsed order data in a database. The parsed order data can be used to link different parent orders to one or more associated child orders. Using this data, the technology can generate a graphical user interface that shows the relationship between the parent order and child order data.

In particular, when generating the graphical user interface, the system can display the plurality of individual “child” orders in the user interface (as child order objects) while showing the associated “parent” orders for each order (as parent order objects). When a parent order object is selected, the graphical user interface updates to highlight the associated child order objects. The technology allows for efficient display of order data in a manner visually conveying the association between parent and child orders, for example, in an electronic trading system.

This Summary is provided to introduce a selection of concepts in a simplified form that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

FIGS. 1A and 1B depict non-limiting example block diagrams of a system;

FIG. 2 depicts a non-limiting example block diagram of different software components comprising the system;

FIG. 3 shows a non-limiting example communication process between different devices;

FIG. 4 shows a non-limiting example data file communicated between devices in the system;

FIGS. 5A and 5B show non-limiting example flowcharts for processes carried out in the system;

FIGS. 6A and 6B show non-limiting example user interfaces generated for display; and

FIG. 7 shows a non-limiting example block diagram of hardware components comprising the system shown, at least, in FIG. 2.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Sections are used in this Detailed Description solely in order to orient the reader as to the general subject matter of each section; as will be seen below, the description of many features spans multiple sections, and headings should not be read as affecting the meaning of the description included in any section.

### Overview

The technology described herein relates to, among other topics, a system for generating a user interface that conveys information related to orders submitted and processed by an order processing system (e.g., an electronic exchange). In one example, electronic exchange systems allow different entities (e.g., brokers, traders) to conduct trading in various instruments including security instruments. Once a transaction is initiated by a broker, trader or other entity, the entire process, including the matching of buyers and sellers and the completion of the transaction, can be performed electronically. These electronic exchange systems enable large numbers (e.g., several hundred thousands to millions) of trades to execute during a trading day. Many of these trades are completed almost instantaneously (e.g., a fraction of a second) upon a buy or sell order being input to the exchange system and/or the input bid or offer prices matching the market price.

In one non-limiting example, some entities may use a third party in order to carry out their trades. For example, a hedge fund may want to place a very large order with the exchange system. Rather than submitting the entire order directly to the exchange system, the hedge fund may have one or more brokers they use to handle the orders and/or break up the orders into smaller orders.

Once the broker(s) receive the order, they may create a plurality of individual “child” orders stemming from the order from the hedge fund (i.e., the “parent” order). The individual “child” orders will then be submitted to the exchange where they will either match with other orders or be stored in an order book for future processing.

The technology described herein can generate a graphical user interface (also referred to as just a “user interface”) that provides one or more visualizations related to orders. The term “order object” is used herein to refer to a visual artifact or other user interface element in the graphical user interface that indicates some activity (e.g., entry, amendment, cancellation, or execution/trading) for an order. The term “parent order object” is used herein to refer to an order object that corresponds to some activity for a parent order, and the term “child order object” is used herein to refer to an order object that corresponds to some activity for a child order. The graphical user interface can display many parent/child order object groups (e.g., multiple parent order objects each have an associated plural number of child order objects) at the same time (e.g., concurrently). The graphical user interface may include filtering functionality that is configured to show order objects for a single set of associated parent/child orders (e.g., one parent order object and the multiple child order objects associated therewith). In one non-limiting example, a user can select a parent order object, and the graphical user interface can highlight the corresponding child order objects for that parent—e.g., by temporarily not displaying other child order objects and/or parent order objects in the graphical user interface.

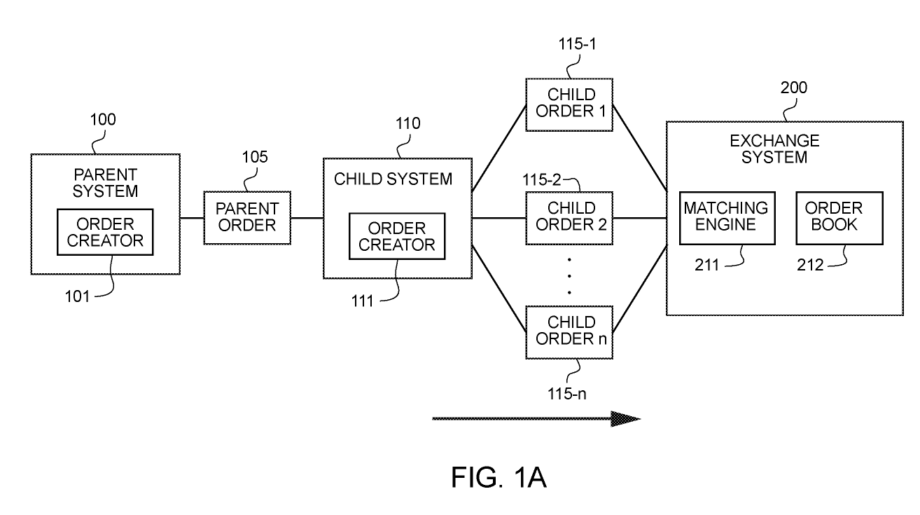

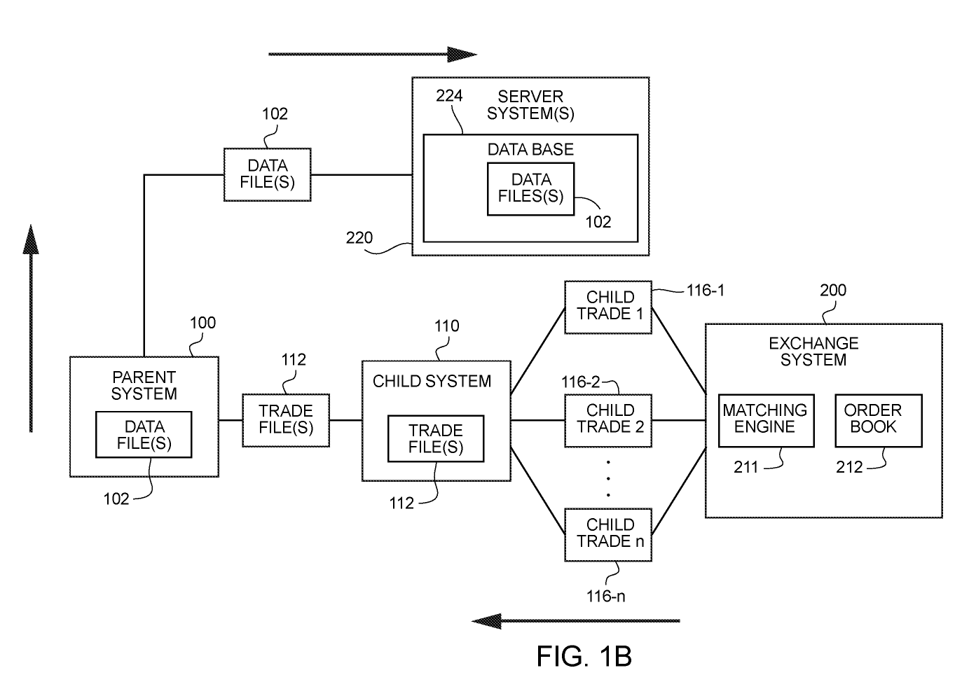

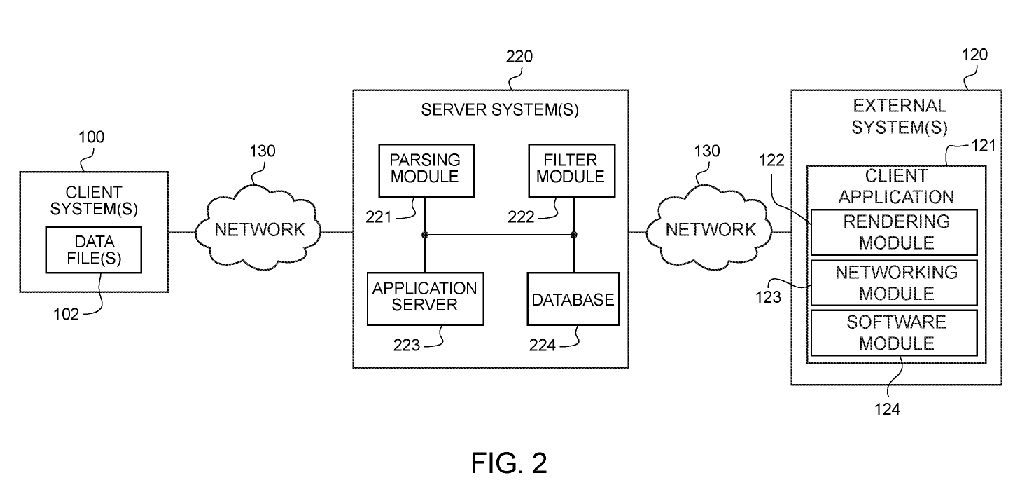

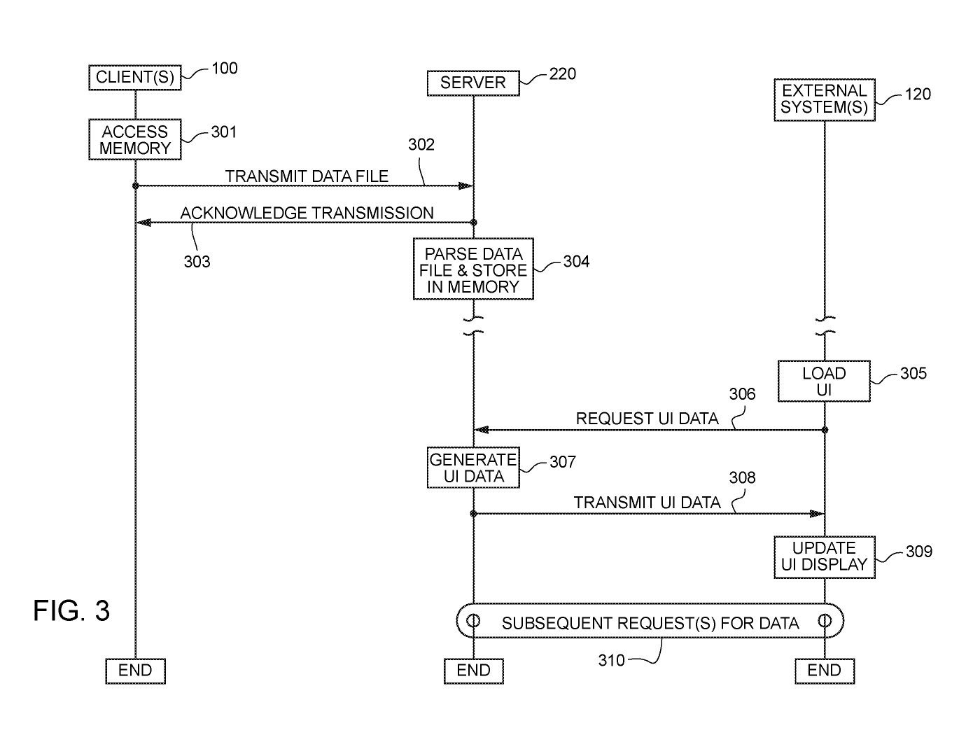

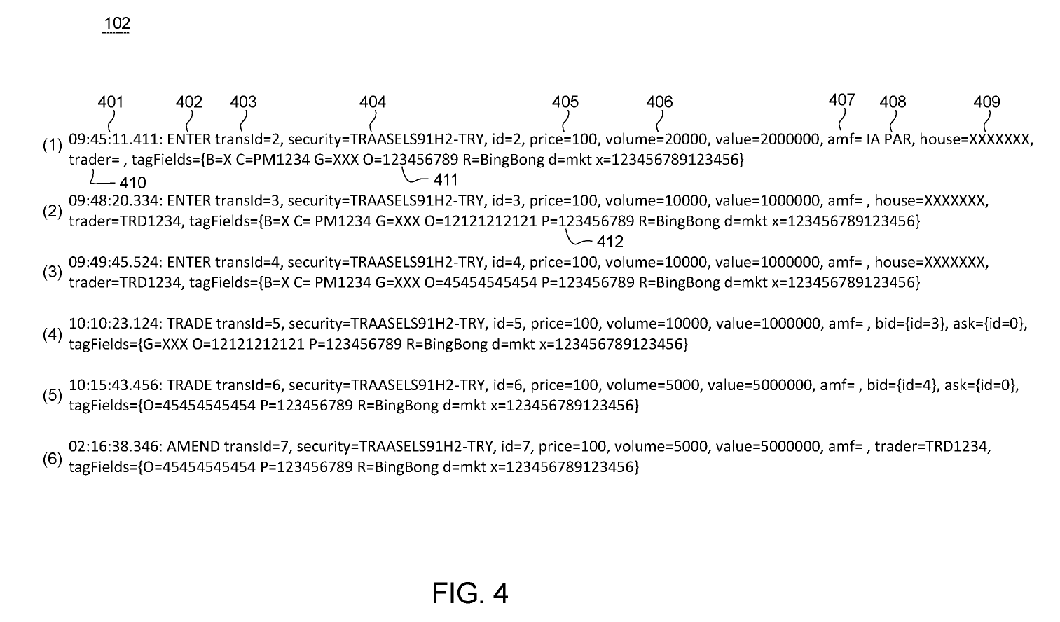

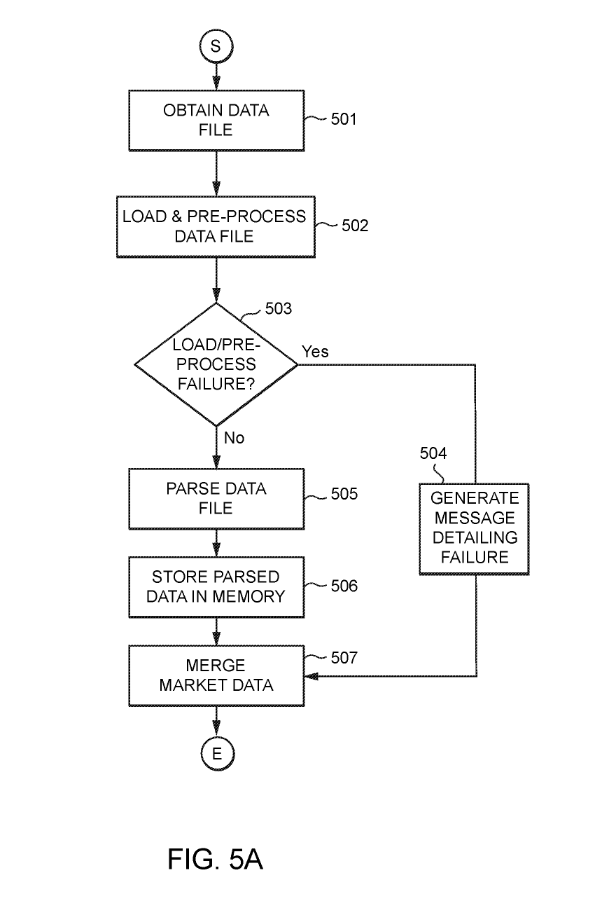

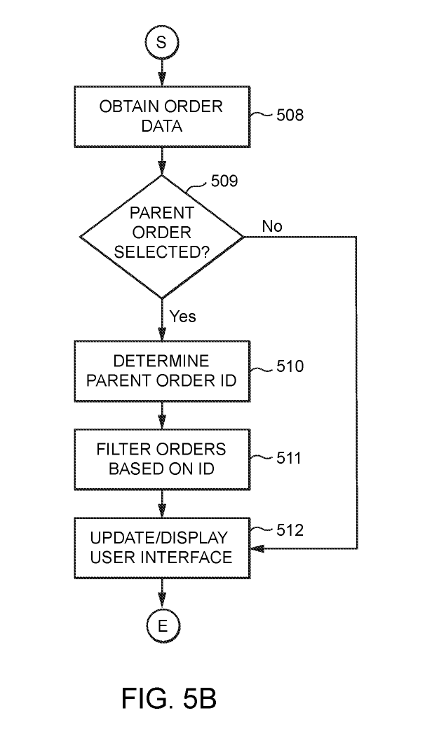

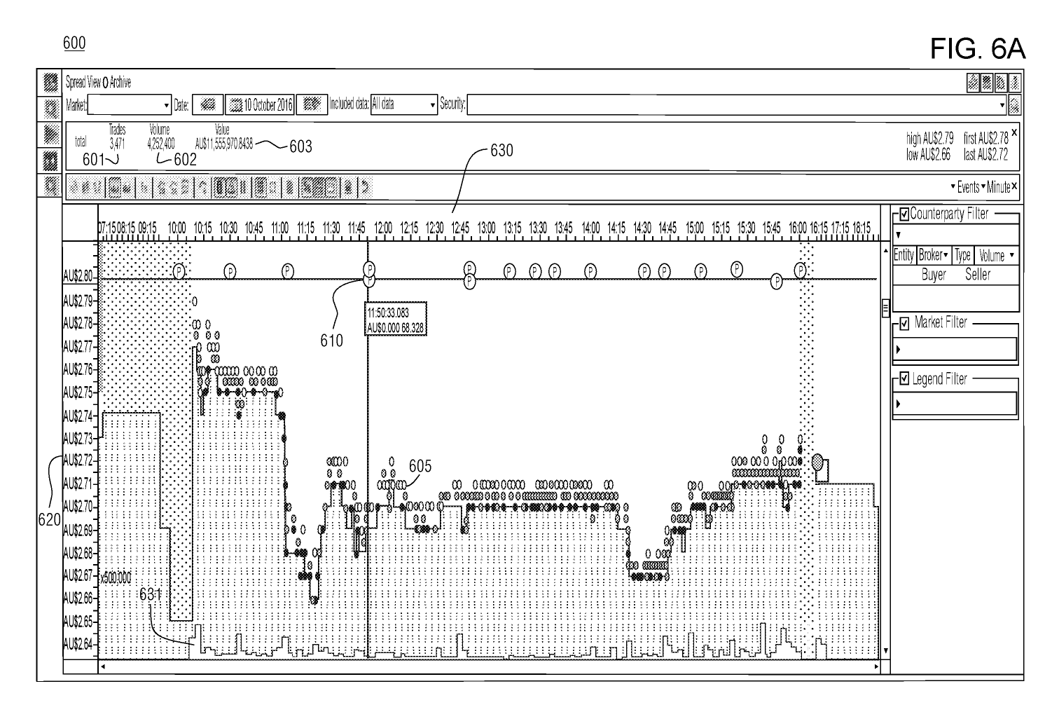

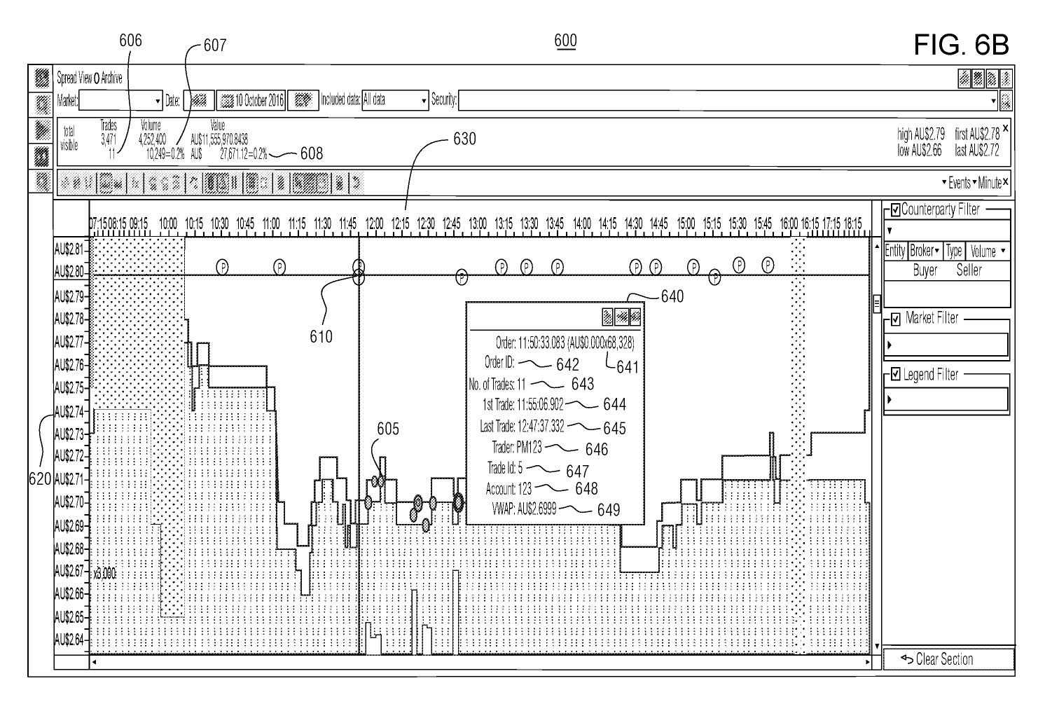

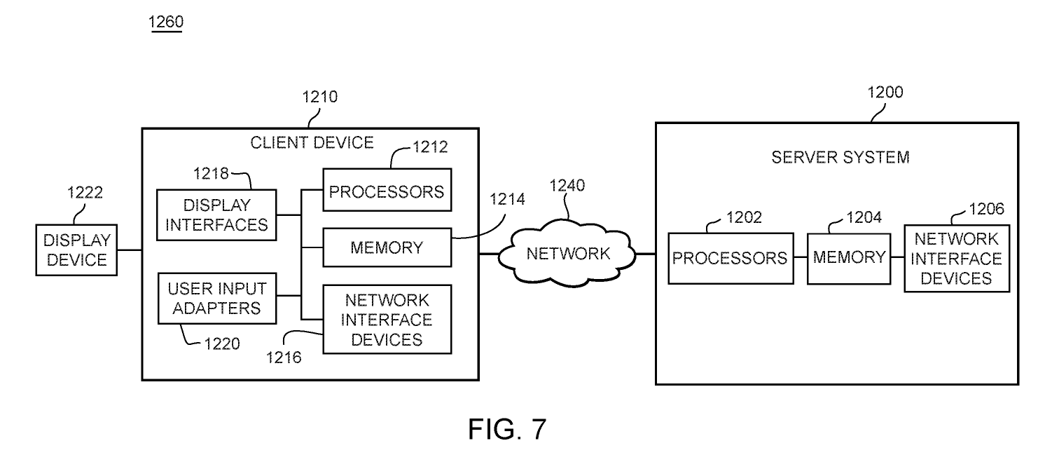

FIGS. 1A and 1B show example systems in which orders are processed (e.g., by an electronic exchange system) and order/trade data is communicated. FIG. 2 shows an example system for generating a user interface that depicts a relationship between parent and child orders, wherein software architecture aspects of the system are highlighted. FIG. 3 shows a communication process between client system(s), server system(s), and external system(s) for obtaining data related to orders and then creating a user interface depicting relationships between parent and child orders. FIG. 4 shows a non-limiting example data file that can be transmitted by a client system and then processed by a server system, as depicted in FIGS. 1B and 2, in order to generate data represented in the user interface shown in FIGS. 6A and 6B. FIGS. 5A and 5B show non-limiting example flowcharts for processing data files (e.g., of FIG. 4) containing order data and generating a user interface. FIGS. 6A and 6B show non-limiting example user interfaces showing relationships between parent and child orders. FIG. 7 shows an example system in which the features described herein may be implemented, wherein hardware aspects of the system are highlighted.

In many places in this document, software modules and actions performed by software modules are described. This is done for ease of description; it should be understood that, whenever it is described in this document that a software module performs any action, the action is in actuality performed by underlying hardware components (such as a processor and a memory) according to the instructions and data that comprise the software module.

### Description of FIGS. 1A and 1B

FIGS. 1A and 1B show non-limiting example system for processing order data. FIG. 1A shows a non-limiting example system where orders can be transmitted from a parent system 100 to a client system 110, and orders from the client system 110 are then transmitted to an exchange system 200. In one non-limiting example, the exchange system 200 can accept order data messages from different client devices and then use a matching engine 211 in the exchange system 200 to attempt to match the order(s) contained in the order data messages. If a match is found, the order will process (e.g., trade) and the parties associated with the order receive confirmation messages that the order executed. If no match is found, the order is be stored in an order book 212 memory in the exchange system 200 (e.g., for later matching with future orders).

In the example shown in FIG. 1A, different orders may be communicated between several systems before the order data is received by the exchange system 200. For example, client systems (e.g., parent system 100 and child system 110) may communicate order messages between each other before the messages are transmitted to the exchange system 200. In one non-limiting example, parent system 100 could include one or more computers operated by an entity such as, for example, a hedge fund that enables entities or individuals to trade various tradeable instruments. Each parent system 100 could contain an order creator 101 that automatically (or manually via user input) creates parent order(s) 105. In one non-limiting example, the parent order(s) 105 could contain one or more order data messages that contain information for carrying out an order request for an entity associated with parent system(s) 100.

A child system 110 could receive the parent order(s) 105 for additional processing. In one non-limiting example, child system 110 may divide parent order(s) 105 into further individual orders that, when taken as a whole, comprise the entire parent order(s) 105. Likewise, child system 110 may only receive a portion of parent order(s) 105 and parent system 100 could send multiple parent order(s) 105 messages to a variety of different child system(s) 110.

Child system 110 could further comprise its own order creator 111 that is used to generate order data messages transmittable to an exchange system 200. In the example shown in FIG. 1A, child system 110 may divide the parent order(s) 105 into one or more child order(s) 115-1-115-n using order creator 111. These child order(s) 115-1-115-n comprise further order data messages that are individually transmitted to exchange system 200 for processing (and possible matching). It should be appreciated that the system(s) 100, 110, and 200 employ a variety of communication circuitry, as well as processing circuitry that includes input/output devices, data transceivers (for transmission of digital and/or analog signals), one or more processors (e.g., a CPU), one or more storage devices (e.g., a memory), and/or one or more audio/visual components (e.g., sound interface, display). Such components are highlighted and discussed with respect to FIG. 7.

FIG. 1B shows a non-limiting example system where trade data is communicated from an exchange system to a child system, a trade file is communicated between the child system and parent system, and a data file is then communicated between the parent system and a server system 220 (which will also be referred to herein as “server 220”). Using the example shown in FIG. 1A, when one or more child order(s) 115-1-115-n match at exchange system 200 (e.g., via the matching engine 211), the exchange system 200 can generate data reporting the trade to child system 110. For example, exchange system 200 can generate one or more child trade(s) 116-1-116-n indicating that a child order has executed as a trade (i.e., matched). The child trade(s) 116-1-116-n could be data messages between exchange system 200 and child system 110 containing different details related to trades of one or more child orders. For example, the data message could include data elements indicating the type of instrument traded, the specific instrument traded, a trade price for the instrument, a volume traded for the instrument, identifiers related to the child order and/or parent order, and/or flag data indicating whether the order is a parent order (or child order). These data elements are non-limiting and the technology described herein envisions any combination and/or number of different data elements that could be included in the data message.

Child system 110 can receive and accumulate the data messages in child trade(s) 116-1-116-n and store the same in a memory of child system 110. In one non-limiting example, child system 110 will store the data messages as trade file(s) 112 in the memory of the child system 110. The trade file(s) 112 could contain one or more data files containing certain elements transmitted in the data messages of child trade(s) 116-1-116-n. In one non-limiting example, child system 110 may parse the data messages for extracting certain elements and such information may be stored in trade file(s) 112.

The data collected and stored in trade file(s) 112 may be transmitted to parent system 100. In one non-limiting example, the trade file(s) 112 may be an “overnight order listing” containing all trade information related to orders placed by parent system 100 with child system 110 for a given day (or any other period of time). The trade file(s) 112 may be a flat file transmitted to parent system 100 (or “picked up” by parent system 100 at a specified period of time). In one non-limiting example, the trade file(s) 112 may be a comma separated flat file having records containing individual elements associated with trade data as seen, for example, in FIG. 4 and discussed in further detail below.

The parent system 100 may receive the trade file(s) 112 and store them as data file(s) 102 in a memory of the parent system 100. In one non-limiting example, the parent system 100 may use the same information provided in trade file(s) 112, or may modify the information received in trade file(s) 112 when storing as data file(s) 102. For example, parent system 100 may reformat the data elements presented in trade file(s) 112 so that they can be stored and later processed by the parent system 100 or another system (e.g., server system 220). The data file(s) 102 may be transmitted from the parent system 100 to server system 220 where server system 220 can parse the data and store the same in a database 224 of the server system 220. The content of the data file(s) 102, as well as the processes for parsing the file(s) 102, storing the parsed data in memory, and generating a user interface is discussed in further detail with respect to FIGS. 2-7, below. It should be appreciated that the server system(s) 220 may be a separate system from exchange system 200 or could alternatively be the same as exchange system 200.

### Description of FIG. 2

FIG. 2 shows a non-limiting example diagram of a system wherein the framework for processing order data and generating a user interface can be implemented. As will be described below, one or more applications that implement the framework for processing order data and generating the user interface can be deployed in the system, and the various components in the system shown in FIG. 2 (such as the client system(s) 100, server system(s) 220, and/or external system(s) 120) can perform different functions related to the deployed applications. In one non-limiting example, the external system(s) 120 may constitute a surveillance system for monitoring market data in order to, for example, spot fraudulent or illegal activity.

As will be discussed below, FIG. 2 shows software modules (such as the software module 124) executing at the external system(s) 120, server system(s) 220, and the client system(s) 100; it should be understood that the software modules shown in FIG. 2 are stored in and executed by hardware components (such as processors and memories); details regarding example hardware components that may be used to execute these software modules are provided below with reference to FIG. 7, as well as in other places in this document.

One or more client system(s) 100 can be configured to produce data file(s) 102 containing data associated with orders generated by system(s) 100. The data file 102 could be an electronic data message and/or a data file formatted for processing by server system(s) 220. For example, data file 102 could be in the form of an XML file having different tags that are associated with data entries processed by system(s) 220. In another example embodiment, data file 102 could be a flat file having different entries separated by delimiters denoting different fields. In one example, the delimiters could be commas (e.g., a comma separated file). This example is non-limiting and the technology described herein envisions any type of delimiters for separating data elements in the data file 102. Elements comprising the data file 102 are shown, for example, in FIG. 4 and discussed in detail below.

It should be appreciated that client system(s) 100 may be any client system interacting directly or indirectly with server system(s) 220. Using the example from FIG. 1A, client system(s) 100 could be parent system(s) 100, child system(s) 110, or any other client system directly or indirectly communicating with server system(s) 220. In one example, client system(s) 100 could be a client system associated with a hedge fund and the data file(s) 102 generated by client system(s) 100 could be an “end-of-day” trading file providing all trading details for the hedge fund for that day (or any period of time).

Server system(s) 220 are configured to communicate with client system(s) 100 and external system(s) 120 (e.g., via network 130). It should be appreciated that the network 130 could comprise a network of interconnected computing devices, such as the Internet. The network 130 could also comprise a local area network (LAN) or could comprise a peer-to-peer connection between the different devices in the system. The server system(s) 220 could comprise any variety of server devices including, but not limited to, database servers, file servers, web servers, application servers, a server cluster (e.g., a cloud-based computing environment), a standalone server, and/or any other portable or stationary computing device having server-based capabilities. It should be appreciated that the server system(s) 220 can be implemented using separately located hardware (e.g., remote hardware) or can be implemented using a same piece of hardware (e.g., within a single housed server device).

Server system(s) 220 can receive the data file(s) 102 from client system(s) 100 via network 130. Upon receiving data file(s) 102, the parsing module 221 of server system(s) 220 is configured to parse different elements in the data file(s) 102. In one example, the data file(s) 102 may be a comma separated data file where one or more commas separate the data elements in each data entry. Parsing module 221 is configured to search for the respective delimiter (e.g., a comma) and then extract individual data elements from the file for storage.

Once the file has been parsed, the server system(s) 220 can store the parsed data in database 224. The database 224 may be or include one or more of: a relational database management system (RDBMS); an object-oriented database management system (OODBMS); an object-relational database management system (ORDBMS); a not-only structured query language (NoSQL) data store; an object cache; a distributed file system; a data cluster (based on technology such as Hadoop); and/or any other appropriate type of data storage system).

The server system 220 can further include an application server 223 that can, for example, execute server-side (or “back end”) instructions for applications that run on the server system 220. In one non-limiting example, the application server 223 may generate data associated with a user interface that is displayable on a display connected to external system(s) 120. The server system(s) 220 may also contain a filter module 222 that is configured to filter data transmitted to external system(s) 120, particularly when generating a user interface for display. In one example, the filter module 222 may be configured to filter order data so that only order data associated with a parent order are transmitted to external system(s) 120.

The external system(s) 120 can include software components for performing processing related to applications deployed in the system. As a non-limiting example, the external system(s) 120 may have a client application 121 consisting of, at least, a rendering module 122, a networking module 123 and a software module 124. Of course, these modules are a non-limiting example, and the application 121 can comprise several more modules and/or different modules than those shown in FIG. 2. The external system(s) 120 could comprise any variety of client-based devices including, but not limited to, a personal computer (e.g., a desktop computer, a laptop computer), a thin client, a hybrid client, a rich client, a game console, a tablet, a personal digital assistant (PDA), a smartphone, a digital music player having web interface capabilities, and/or any other portable or stationary computing device.

The rendering module 122 in the external system(s) 120 can implement functionality for the graphical display and rendering of user interfaces. It can, for example, generate graphical data that corresponds to an image class that represents graphical images processed by the client application 121; this graphical data can, potentially after further modification/transformation by the operating system of the external system(s) 120, be displayed on a display of the system(s) 120. Alternatively or additionally, whenever it is described in this document that the external system(s) 120 renders/displays image data, the rendering/displaying module 122 may perform functionality related to the rendering/display of the image data.

The networking module 123 can implement one or more networking/communication protocols, and be used to handle various data messages between the external system(s) 120 and, at least, the server system(s) 220. In one non-limiting example, the networking module 123 may carry out a socket connection by using a software connection class to initiate the socket connection between devices. Once the sockets are connected, networking module 123 may transfer data to/from the server system 220.

The software module 124 can be used to execute various code loaded at the client application 121, and perform other functionality related to the software. The software module 124 may be, for example, a Java runtime engine or any other type of software module capable of executing computer instructions developed using the Java programming language. This example is of course non-limiting and the software module 124 may execute computer instructions developed using any variety of programming languages including, but not limited to, C, C++, C#, Python, JavaScript, or PHP. Alternatively or additionally, whenever it is described in this document that the external system(s) 120 performs functionality related to the software module, such functionality may be handled by the software module 124.

It should be appreciated that the components shown in FIG. 2 can be implemented within a single system. The components could also be incorporated in multiple systems and/or a distributed computing environment (e.g., a cloud computing environment). Thus, the system is not limited to a single component and can be incorporated into multiple components.

### Description of FIG. 3

FIG. 3 shows a non-limiting example communication process between devices within the system. The communication process shows example communication between at least one client system 100, server system 220, and external system 120. It should be appreciated that this communication process can be carried out, for example, using network 130. In one non-limiting example, the processes shown in FIG. 3 begin after the parent system 100 (shown in FIGS. 1A and 1B) has received the trade file(s) 112 from child system 110.

In the example shown in FIG. 3, the communication process begins when client system 100 accesses a memory storage at action 301 in order to retrieve the data file 102. For example, client 100 may have a pre-stored flat file in a memory storage associated with client 100. Alternatively, client 100 may run a query assembling all of the elements needed for the data file 102 in order to prepare the data file 102 for transmission. In one example, the data file 102 will represent all trading activity that has occurred for one or more entities associated with client 100 for a given day. The data file 102 could be an end-of-day trading file, as discussed with respect to data file(s) 102 above.

Once the data file 102 is ready for transmission, client 100 can transmit the data file 102 to server 220 at action 302. In one example, client 100 can establish a network connection with server 220 and actively transmit the data file 102 to server 220. In another non-limiting example, client 100 may retrieve the data file 102 and then place the data file 102 into a file storage location that is accessible by server 220 for retrieval. That is, client 100 may put the data file 102 into a “folder” that is accessible by server 220 and server 220 will obtain the data file 102 once available (or at any time after the data file 102 is available). It should be appreciated that the steps carried out between client 100 and server 220 are non-limiting and the technology envisions a variety of methods in which the data file 102 can be transmitted to server 220. For example, server 220 may actively request data file 102 from client system 100.

Client system 100 may also be programmed to prepare the data file 102 for pick-up by server 220 and store the data file 102 into a memory location serving as a temporary “pick-up” area for server 220. Server 220, at some point in time after the data file 102 is available, may then obtain the data file 102 from client 100 by accessing the memory location serving as the “pick-up” area for the file. The examples discussed above refer to a single data file 102, but it should be appreciated that the client 100 and server 220 may communicate a plurality of data files 102 between each other. It should further be appreciated that client 100 and server 220, instead of transferring a data file 102, may communicate the individual data contained within the data file 102 (e.g., during a real-time communication session between client 100 and server 220).

Upon receiving the data file 102, server 220 may, at action 303, acknowledge receipt of the data file 102 by sending a return message to client 100. In one non-limiting example, server 220 may send an acknowledgment of receipt message indicating that the data file 102 has been successfully received by server 220, or may issue a message indicating that transfer of the data file 102 has failed. In yet another non-limiting example, server 220 may analyze data file 102 to determine if data file 102 contains any data and/or is properly formatted. If data file 102 does not contain any data and/or is improperly formatted, server 220 may reject receipt of data file 102 and send a message to client 100 providing indication of the issue with receiving data file 102. Alternatively, server 220 may store data file 102 but continue to issue a message to client 100 indicating the problems with data file 102.

At action 304, server 220 may parse the elements of the data file 102 in order to extract individual elements for storage and processing. In one example, the data file 102 will be a comma separated file in which the server 220 may be able to identify and parse individual elements from the data file 102. For example, the data file 102 may identify a type of security being traded, a price, and volume of the security. Each of these individual elements (e.g., type of security, price, volume) may be separated by a comma (or some other type of delimiter) in the data file 102 where server 220 can identify as being separate from each other and, based on a predetermined location of the element with each “record” of the data file 102, obtain the elements and store them in memory. For example, upon successfully parsing each record entry in the data file 102, the server 220 may store the associated elements into relevant portions of one or more tables of a database memory of server 220. For example, the server may create a first record for a parent order that includes the order identifier (e.g., as a column in the table) for that parent order. This record may include a flag or other data that indicates this order is a parent order. The server may also create records for child orders that include an order identifier (e.g., in the same or different column in the same or different table as the parent order is stored). Each record for a child order that is stored in the table may also include a parent order identifier (e.g. that is a separate column in the table than the order identifier) that references the order identifier for the parent order. Thus, the child orders for a parent order may be linked by virtue of value of the parent order identifier for a child order being the same as the order identifier for the parent order. Further details regarding how this parsing may be performed in some embodiments are provided below with respect to FIG. 4 and FIG. 5A (including, without limitation, with respect to action 505).

At action 305, external system 120 may load a user interface for display on a display device operatively coupled to system 120. For example, system 120 may load an application that can generate a user interface for displaying information related to one or more orders/trades associated with different entities that have conducted exchanges via server 220. In doing so, external system 120 may, at action 306, request data for populating and/or rendering the user interface. For example, the user interface may display data that shows different objects representing trades that were matched by server 220 along a graph representing a time of the trade along one axis and a value of the trade along another axis.

The data required to populate the display with these elements may be generated by server 220 at action 307. In one non-limiting example, the system 120 may have requested data related to all trades that occurred on a given day (or any other period of time) for one or more entities (e.g., brokers, individuals, hedge funds). The server 220 may then access a database to obtain the relevant information requested in the query from system 120 and then transmit such data to system 120 at action 308. In one example embodiment, server 220 may only transmit data elements related to trades having associated “parent” orders. In this example embodiment, server 220, rather than searching each individual trade stored in memory, may only query trades having an associated “parent” flag indicating that the trade is involved with another, possibly larger volume “parent” order. The server 220 will thus reduce the amount of data searched in memory and will further reduce the amount of data transmitted to system 120 thereby reducing overall communication latency between the devices.

At action 309, external system 120 may generate/update the user interface being displayed using the data received from server 220 at action 308. In one non-limiting example, system 120 may populate a graph where individual elements can be plotted representing individual trades executed by server 220 and additional elements representing a (possibly larger volume) “parent” order associated with one or more of the individual “child” trades. The elements can be plotted and displayed in a manner where the displayed/plotted location represents, for example, a time of the order and/or value of the order. Such an example of a user interface can be seen with respect to FIGS. 6A and 6B, discussed in further detail below.

At action 310, external system 120 may make subsequent requests (either automatically or via user manipulation) for data in updating and/or further generating additional displays related to the user interface. Although actions 301-310 are shown in FIG. 3 as occurring once, these actions 301-310 may, in various embodiments, be repeated a number of times.

### Description of FIG. 4

FIG. 4 shows a non-limiting example data file 102 that is communicated between, at least, client 100 and server 220. In the example shown in FIG. 4, data file 102 will contain various data “records” where each individual element in the records are separated by a delimiter (e.g., a comma). This example is of course non-limiting and the technology described herein envisions any variety of delimiters that can be used to separated data elements including, but not limited to, colons, semi-colons, and/or tab delimiters, and/or the technology described herein use other (non-delimited) file types. Further, it should be understood that while example “records” and “elements” are described herein (including but not limited to in the following description of FIG. 4), such “records” and “elements” may, in various embodiments, be any type(s) of suitable data structure(s).

In the example shown in FIG. 4, the records in data file 102 may relate to one or more tradeable instruments (e.g., securities) that are traded/exchanged via exchange system 200. Each record could thus contain individual data elements associated with different information related to activity that occurred with respect to a particular order. For example, the record could contain time element 401 indicating the time in which an order was processed/execute by exchange system 200. In this example, the records contained in data file 102 may not contain a specific date for the order as each individual data file 102 may be in-and-of itself associated with a date. For example, the data file 102 could correspond to an end-of-day file associated with one or more orders processed (e.g., for a given day) in association with client 100. Thus, all data elements associated with time element 401 will be automatically associated with the specific date of the data file 102. Of course, this example is non-limiting and the technology described herein envisions each record further including information associated with a specific date (or another element in each record identifying a specific date).

Each record can include an order activity type 402 and transaction identifier (ID) 403. In one non-limiting example, order activity type 402 may identify the type of activity (e.g., entry, modification, or execution/trading) that occurred with respect to the order to which the record corresponds. For example, and as shown in FIG. 4, an order activity type 402 of “ENTER” may indicate that the record corresponds to initial entry of an order, while “AMEND” and “TRADE” activity types indicate that the record corresponds to when an order has been amended or executed as a trade, respectively. These values are of course non-limiting and the technology envisions a variety of values that could be represented as an element for order activity type 402. Additionally, a record may have a specific numerical identifier identifying the transaction ID 403. In the example shown in FIG. 4, each record is sorted in a manner indicating sequence for each transaction (i.e., transId=2 is listed first, transId=3 is listed second, transId=4 is listed third, etc.).

As mentioned above, each record may be associated with different instruments that are tradeable via exchange system 200. In the example shown in FIG. 4, each record contains information related to the trading of one or more securities. For example, security identifier 404 may identify a specific type of security, where price element 405 and volume element 406 can convey information related to the price and quantity associated with the order. In the first record shown in FIG. 4, security 404 is identified as “TRAASELS91H2-TRY,” and the order had a price 405 value of “100” and volume 406 value of “20000.”

Each record may also have flag elements 407 that contain identification information indicating different flags related to a type and/or status of the order represented in the record. Certain example flag elements may include flags “se,” “MO,” and “IA” indicating flags for a Sell Order (SO), Market Order (MO), and an order that is Inactive (IA), respectively.

For the orders represented in the data file 102, some of the orders are child orders that are associated with parent orders. If a given record is for a parent order, the flag element 407 for the record can include a parent flag 408 indicating that the order represented in the record is a parent order. For example, parent flag 408 may be identified when the characters “PAR” are present in association with flag element 407. In the example shown in FIG. 4, record (1) is for a parent order (as it contains parent flag 408), while records (2)-(6) are not for parent orders. If no parent flag 408 is present in a record, then it can be understood that the order is associated with a child order. In other words, system may be programmed to classify or identify an order as a parent order based on the presence of the parent flag in the corresponding record. Child orders may be identify or classified based on determination that a record does not contain a parent flag. In certain examples, identification or classification of a child order may be based on determination that a parent order identifier is present in the record (thus indicating that the corresponding order has a parent order).

Each order can be identified based on an order identifier 411. In the example of the first record shown in FIG. 4, order identifier 411 contains the value “123456789” indicating the identification value for the order. In an instance where the same order is represented in multiple records, the order's identifier 411 will be included as the order identifier in those records. In the example of FIG. 4, at least records (2) and (4) relate to the same order having order identifier 411 “O=12121212121.” In this example, record (2) is associated with when the order was entered (identified by order activity type 402 “ENTER”) while record (4) is associated with the order being executed/traded (identified by order activity type 402 “TRADE”).

In the data file 102, a record for a child order may include a separate field indicating the identifier for the associated parent order identifier. That is, if a record does not contain parent flag 408, the record may correspond to a child order and may contain another field that includes the order identifier for the parent order associated with the child order. For example, a record may contain a parent order identifier 412 field with a value “P=” where the elements following the equal sign could include the order identifier of a parent order. In the example shown in FIG. 4, records (2)-(6) correspond to child orders associated with a parent order having an order identifier 411 value of “O=123456789” (represented in detail in record (1)); as can be seen in FIG. 4, each of records (2)-(6) includes a parent order identifier with a value of “P=123456789” (with, in the case of record (2), the parent order identifier included in parent order identifier field 412). Thus, it can be understood that records (2)-(6) do not correspond to a parent order (by virtue of the parent flag 408 being omitted), and they instead correspond to child orders; and it can be further understood that the parent order to which these child orders are associated has parent order identifier 412. It should be appreciated that these child orders can still be identified using their own order identifiers (i.e., as “O=” where the value following the equal sign corresponds to the child order identifier). In the example shown in FIG. 4, records (2) and (4) are affiliated with one child order (i.e., “O=12121212121”) while records (3), (5), and (6) are associated with another child order (i.e., “O=45454545454”). These examples are non-limiting and the technology described herein envisions a variety of methods for identifying different parent and child orders.

The orders represented in the data file 102 can be associated with one or more parties/entities. For example, each order may be associated with a broker initiating the order, an entity requesting the broker to carry out the order (e.g., an individual, a hedge fund, a corporation), a type of exchange that conducts the transaction, and/or a specific clearinghouse that clears the order post-matching. In the example shown in FIG. 4, house identifier 409 may identify a specific house associated with the order (e.g., a clearinghouse). Each record may also identify a specific trader (or other party) associated with the order using, for example, trader identifier 410. It should be appreciated that the data elements discussed in this example are non-limiting and the technology described herein envisions any variety of additional data elements providing further information associated with each data record.

### Description of FIGS. 5A & 5B

FIGS. 5A and 5B show non-limiting example methods carried out by components in the system for obtaining information for and rendering of a user interface for display. FIG. 5A specifically shows a process that can be carried out, for example, by server 220 for processing the data file 102 received from client 100.

At action 501, server 220 may obtain/receive data file 102 from client 100 containing the information associated with one or more orders; in some embodiments, the data file 102 may include information as shown in FIG. 4. The data file 102 may be a comma separated flat file or other type of file, and the data file 102 could be transmitted to the server 220 using a variety of methods. For example, instead of a comma separated flat file, data file 102 may be an XML file having different elements associated with an individual trade identified by different “tags” in the XML file. The server 220 could identify the individual elements based on the “tag” identifiers and then extract the information associated with each element following the “tag” identifier.

At action 502, server 220 may load and pre-process the data file 102. In one non-limiting example, server 220 may load and analyze the data file 102 to ensure that the data file 102 is ready for processing. For example, the server 220 may confirm the data file 102 includes content having the records as discussed with respect to FIG. 4. Server 220 may also determine if the format of the data file 102 is proper for pre-processing. For example, server 220 may confirm that the data file 102 is a comma separated data file where each individual element in the records are separated by a comma.

At action 503, server 220 may then determine if a failure occurred during load and pre-processing in action 502. If a failure occurred, server 220 may generate a message detailing the load/pre-processing failure at action 504. In one non-limiting example, server 220 may generate an email message that can be sent to a client device detailing the specific error that occurred during load/pre-processing. For example, server 220 may automatically generate a message indicating that the data file 102 load failed, or indicating that the data file 102 is corrupt (or in an improper format).

If no failure occurred, the server 220, at action 505, may parse the data file 102 (i.e., may parse the order data contained therein, including records/elements within the order data). This may be performed using the methods described above (e.g., with respect to action 304, with respect to FIG. 4, and/or in other places above), and/or as described as follows.

In the example of a comma separated data file, the data file 102 may be arranged such that the sequence of elements listed from left-to-right are positioned in a pre-determined order. As such, the server 220 at action 505 will know which element corresponds to an associated piece of information in the data record based on the position in left-to-right sequence. For example, the first string of data, before the first comma in the record, may always be associated with the transaction identifier 403, the time 401 in which the trade was processed, and order activity type 402. Alternatively, the server 220 may be able to identify different pre-defined identifiers across each element in the data record. For example, server 220 may identify certain characters in a data element and then be able to understand that the data element is associated with a specific field. Using the example record in FIG. 4, when server 220 parses a data element having the term “price,” server 220 will know that the value following an “=” sign will be the corresponding price value. The server 220 may employ any variety of methods for parsing and identifying individual data elements and this example is thus non-limiting.

In some embodiments, the parsing by the server 220 at action 505 may include searching the order data to identify parent orders contained therein, to identify child orders contained therein, and to identify correspondences between the identified parent orders and the identified child orders based. In some embodiments, the order data may include records such as the records shown in FIG. 4, which may include order identifier elements (e.g., order identifier 411) parent flag elements (e.g., parent flag 408), parent order identifier element (e.g., parent order identifier 412), and other elements. In such embodiments, this parsing may include operations such as (a) identifying a parent order as such on the basis that a record for the parent order includes a parent flag element, (b) identifying a child order as such on the basis that a record for the child order includes a parent order identifier element. In such embodiments, this parsing may alternatively or additionally include operations such as:

(x) (1) analyzing a given record in the order data, (2) determining that the given record includes a parent flag element, (3) identifying that the record corresponds to a parent order based on the foregoing determination, and (4) storing the order identifier for the parent order; and

(y) (1) analyzing a given record in the order data, (2) determining that the given record includes a parent order identifier element, (3) comparing the order identifier in the parent order identifier element to the identifier for the parent order from (x), and (4) if the comparison indicates that the order identifier in the parent order identifier element and the identifier for the parent order from (x) are the same, identifying that the given record corresponds to one of the child orders that is associated with the parent order from (x).

Upon parsing the elements in data file 102, the server 220 at action 506 can store the individual elements in, for example, a structured data format that may include one or more tables of a database stored in a memory of server 220. In one non-limiting example, server 220 may have a database containing one or more tables storing each piece of information related to individual trade(s) that is extracted from the records provided in data file 102. For example, each entry in the table may be identified with a unique identifier and the following elements may correspond to the individual trade items that include, at least, the transaction ID 403, order activity type 402, time 401, security 404, price 405, volume 406, and the other remaining elements. The tables could contain additional information not extracted from the data file 102 (e.g., a unique identifier).

At action 507, the server 220 may merge the parsed data with market data. In one non-limiting example, the server 220 may obtain the individual order data that is parsed and stored and such data can then be merged with market data relating to different orders for one or more financial instruments. Merging the stored data with market data allows the user interface to display both the parsed order data as well as the market data (e.g., for a security) in order to convey further information regarding order data for the financial instrument.

FIG. 5B shows a non-limiting flowchart for processes that can be carried out between the interaction of server 220 and system 120, for example. It should be appreciated that the processes carried out with respect to FIG. 5B may occur after the processes with respect to FIG. 5A have been completed. In the example of FIG. 5B, the processes may be carried out substantially by external system 120 when generating certain aspects of the user interface.

At action 508, external system 120 may obtain/receive the order data related to, for example, orders for one or more entities across one or more securities. The system 120 may obtain all order data for a particular entity and/or security, or may request specific order data from server 220 in which server 220 will only provide the necessary data requested. This received order data may include data for parent orders (i.e., parent order data) and data for child orders (i.e., child order data), and it may additionally include data for other orders that are not parent/child orders. In some embodiments, the order data may only include data for child orders for when the child orders were executed/traded (e.g., the order data would not include data related to when the child orders were entered (if the child orders rested after entry), modified, cancelled, etc.); in such embodiments, the child order objects processed/displayed by the external system 120 as described below would only include child order objects for when child orders were executed/traded. In other embodiments, on the other hand, the order data may include data for child orders for all activity related to the child orders (e.g., for when the child orders were entered (if they rested after entry), modified, cancelled, etc.), and the child order objects processed/displayed by the external system 120 as described below would include child order objects for all such activity.

At action 508, after the order data is received, the external system 120 may display the graphical user interface, wherein the graphical user interface includes parent order objects that correspond to the parent orders represented in the order data, child order objects that correspond to the child order objects represented in the order data, and/or order objects that correspond to other orders (i.e., orders that are not parent orders or child orders) represented in the order data. In some embodiments, some or all of the parent order objects may be rendered as a circle that includes the letter “P.” If a specific parent order object has not been selected, the system 120 may display in the graphical user interface all available parent order objects and child order objects. An example of such a display is provided in FIG. 6A, which shows multiple parent order objects and multiple individual child order objects, along with other order objects.

At action 509, the system 120 may receive input from a user (e.g., a via mouse click, a touch input via a touchscreen, etc.) and, in response to the user input, may determine that a parent order object has been selected using the user interface. For example, and as discussed in further detail with respect to FIGS. 6A and 6B and in the following actions 510, 511, and 512, a user may select a parent order object to indicate that details for the corresponding parent order should be emphasized.

At action 510, the system 120 determines the parent order identifier associated with the selected parent order object. This may be performed by accessing a data field in the selected parent order object that indicates the parent order identifier, calling a method in the selected parent order object to obtain the parent order identifier, and/or otherwise searching the data available to the system 120 to obtain the parent order identifier associated with the selected parent order object.

At action 511, the system 120 may filter for the child order objects that correspond to orders/trades that are associated with the corresponding parent order, based on the parent order identifier determined at action 510.

In some embodiments, this filtering may include the system 120 determining which (of all of the available order objects, including the “other” order objects) are child order objects and generating a list of such child order objects. This may include the system 120 searching the available data, identifying all orders having a parent order flag and/or an identifier specifying a specific parent order, and adding the corresponding order objects to the list. Then, the system 120 can traverse the generated list of child order objects and update data to reflect that the child order objects that are not associated with the selected parent order object should not be displayed (e.g., the system may set a “display” flag associated with such order objects to be FALSE). Via this approach, the system 120 does not need to update the display status for all of the available order objects; rather, it does so only for the order objects in the child order object list, which is more efficient.

At action 512, the graphical user interface is updated, such that the child order objects that are not associated with the selected parent order object are not displayed. This may be performed, for example, by the system 120 refreshing the display of the graphical user interface, checking which order objects are set to be displayed and which are not (e.g., by assessing whether a “display” flag associated with each order object is set to TRUE or FALSE), and rendering the graphical user interface accordingly. FIG. 6B shows an example of a graphical user interface as may be displayed at action 512, wherein the only displayed child trade objects are those that are associated with a selected parent order object.

It should be understood that, although actions 501-507 and 508-512 are described above as separate actions with a given ordering/sequence, this is done for ease of description. It should be understood that, in various embodiments, the above-mentioned actions may be performed in various orderings/sequences; alternatively or additionally, portions of the above-described actions 501-507 and 508-512 may be interleaved and/or performed concurrently with portions of the other actions 501-507 and 508-512.

### Description of FIGS. 6A and 6B

FIGS. 6A and 6B show non-limiting example user interfaces that can be displayed on a display operatively coupled to external system 120. In one non-limiting example, the user interface may relate to a display showing different order/trade data associated with orders for one or more security instruments.

FIG. 6A shows a non-limiting example user interface 600 that displays different order objects, including parent order objects, child order objects, and order objects for other orders (i.e., for orders that are not parent orders or child orders). In one non-limiting example, the user interface 600 includes a display portion having a graph with at least two axes that the order objects are plotted on. The graph includes a first axis 610 indicating a time that the display activity took place, and a second axis 620 indicating the price/value at which the displayed activity took place.

In one non-limiting example, child order object 605 is plotted on the graph display of the user interface while parent order object 610 is plotted on the same graph display at a different position than child order object 605. For example, parent order objects 610 can be plotted along a timeline (extending in a direction parallel to the first axis 610) at a position above one or more child order objects 605 along the second axis 620.

The position of an order object (e.g., a parent order object 610 or child order object 605), as plotted on the graph, may correspond to the time at which some activity related to the order that corresponds to the order object took place—e.g., when the order was entered, amended/modified, and/or traded. In one non-limiting example, a parent order object 610 associated with one or more child order objects 605 will be positioned, along the x-axis, first in sequence from left-to-right before the child order objects 605. That is, when viewing the display along the x-axis going from left-to-right, the parent order object 610 will be displayed first before any associated child order objects 605 are displayed. This could be due to a parent order object 610 being placed before the child systems can place the orders with the exchange (for trading). Thus, if a parent order object 610 is shown on the display along the x-axis (from left-to-right) after one or more child order objects 605, such information could be indicative of unusual trading activity (e.g., fraudulent trading activity, insider trading). Such information could also be indicative of one or more systems improperly time-stamping the orders. For example, the data file 102 containing order information (e.g., shown in FIG. 4) may incorrectly timestamp an order entry associated with a parent order. As an example, a parent order may be placed at a first time where a later order entry associated with the parent order (e.g., a “TRADE” or “AMEND” action) may incorrectly timestamp the later entry with the current time rather than the time the parent order was placed. In this instance, the display may incorrectly show the parent order object 610 at a later time than one or more child order objects 605 because of the incorrect timestamp data.

The position of the parent order objects 610 and child order objects 605 is non-limiting and the technology described herein envisions a variety of methods for determining the positions for such order objects. For example, the positions for each parent order object 610 could be determined based on relative relation to determined positions for one or more child order objects 605. In one non-limiting example, the position of the parent order object 610 may be in the median of the collective location of the related child order objects 605. In another non-limiting example, the position of the parent order object 610 may be in a position corresponding to a position of a median child order object 605. For example, if one parent order object 610 corresponds to five child order objects 605, the parent order object 610 position may match the position of the third child order object 605 (i.e., the “median” order in sequence).

It should also be appreciated that each parent order object 610 can be displayed in a format that distinguishes them from the child order objects 605. For example, the parent order object 610 could be displayed in a first format (e.g., with a “P” on the object 610) to indicate that the order is a “parent order,” while the child order object 605 could be displayed in a second format (e.g., that does not involve the use of a “P” on the object 605). This example is non-limiting and the parent order object 610 and child order object 605 could be displayed in formats that are different with respect to the sizes, shapes, and/or colors involved.

Furthermore, the parent order object 610 could be displayed with other identifying information indicating that it is a parent order with a specific type of action associated with the parent order. For example, parent order object 610 could be displayed as a gold icon with the letters “Pe” indicating that the parent order has been entered. Parent order object 610 may also be displayed as a pink icon with the letters “Pa” indicating that the parent order has been amended. Parent order object 610 could also be displayed is a grey icon with the letters “Pd” indicating that the parent order has been deleted. These examples are of course non-limiting and the parent order objects 610 could be displayed in any color and with any type of indication.

The user interface 600 may also include further information related to the different order/trade data. For example, the user interface 600 can include a trade number 601 indicating a number of trades that are associated with one or more securities represented in the displayed graph. The user interface 600 may also include a volume 602 indicating, for example, a number of shares that are traded for one or more securities represented in the displayed graph. The user interface 600 may also include a value 603 indicating, for example, a total dollar amount for one or more securities that are traded and represented in the displayed graph. It should be appreciated that the graph may also contain a bar region 631 that corresponds to a trade volume for a particular order. For example, the size of the bar region 631 for a particular trade may indicate a higher volume order compared to other orders that have processed as trades.

When a user selects one of the parent order objects shown on the user interface, different child orders may be highlighted. FIG. 6B shows the non-limiting example user interface 600 when at least one parent order object 610 has been selected (e.g., by user input). The example shown in FIG. 6B relates to order objects shown in FIG. 6A, but filtered to only show the child order objects 605 associated with the selected parent order object 610. In one non-limiting example, the user interface 600 may remove child order objects 605, not associated with the selected parent order object 610, from display. This example is non-limiting and the technology envisions a variety of methods for highlighting or otherwise indicating the child objects 605 on the display. For example, the display may keep other (e.g., non-linked) child order objects 605 displayed but change the size, shape, and/or color of child order objects 605 associated with a selected parent order object 610. In certain examples, the non-linked child orders may be changed in color, transparency or other visual indicator (e.g., by being greyed out or made transparent). In certain examples, the linked child orders may be changed in color, transparency or other visual indicator to visually show the relationship between a selected parent and its child orders (e.g., by highlighting or changing the orders to a bright color).

The user interface 600 may be further configured to alter the display to include an overlay window 640 that is generated in association with the “filtered” child order objects 605 and parent order object 610. In one non-limiting example, the overlay window 640 may contain details regarding the selected parent order objects 610 and the associated child order objects 605. For example, a user could “left-click” a parent order object 610 to open the overlay window 640 associated with the parent order.

The overlay window 640 could include an order identifier 642 identifying the parent and/or child order(s). The order identifier 642 could be the order ID for a selected parent order event. The window 640 may further include parent order information 641 that could include one or more pieces of information related to a parent order. For example, parent order information 641 could include a date/time a parent order was placed, a value (or price) associated with the parent order, and/or a volume associated with the parent order.

The overlay window 640 may also provide further information related to the one or more child orders associated with the parent order. For example, window 640 may include a child order trade number 643 indicating a number of child orders that were traded/processed in association with a selected parent order. The window 640 could further include a first trade time 644 and a last trade time 645 indicating a time (and/or date) for first and last trades, respectively, of child orders associated with the selected parent order. For example, first trade time 644 could correspond to the time at which the first trade associated with the selected parent order was executed. Likewise, last trade time 645 could correspond to the time at which the last trade associated with the selected parent order was executed.

The overlay window 640 could provide further information related to both the parent and child orders. For example, the window 640 could further include a trader identifier 646 indicating one or more individuals that were associated with (or placed) the trades and a trade identifier 647 indicating an identifier value for at least one trade related to the parent and/or child orders. The window 640 could further include an account identifier 648 indicating an account associated with the parent and/or child orders and a VWAP 649 indicating a volume weighted average price associated with the parent and/or child orders. It should be appreciated that the items shown in overlay window 640 are non-limiting and the technology described herein envisions and variety of data that can be displayed in window 640.

It should be appreciated that the display shown in FIG. 6B may also include further summary information near the top of the user interface. For example, the user interface may include a child trade number 606 value indicating how many child trades are being highlighted. The user interface may further include a child volume 607 indicating, for example, a number of shares that are traded for the highlighted child trades represented in the displayed graph. The child volume 607 may also indicate a percentage value indicating the total percentage the child volume 607 amounts to with respect to volume 602. The user interface may also include a child value 608 indicating, for example, a total dollar amount for the highlighted child trades represented in the displayed graph. Similar to child volume 607, child value 608 may also indicate a percentage value indicating the total percentage child value 608 amounts to with respect to value 603. The summary items shown in FIGS. 6A and 6B are of course a non-limiting example and the technology described herein envisions any variety or modification of summary information that can be shown.

### Description of FIG. 7

FIG. 7 shows a non-limiting example block diagram of a hardware architecture for the system 1260. In the example shown in FIG. 7, the client device 1210 communicates with a server system 1200 via a network 1240. The network 1240 could comprise a network of interconnected computing devices, such as the internet. The network 1240 could also comprise a local area network (LAN) or could comprise a peer-to-peer connection between the client device 1210 and the server system 1200. As will be described below, the hardware elements shown in FIG. 7 could be used to implement the various software components and actions shown and described above as being included in and/or executed at the client device 1210 and server system 1200.

In some embodiments, the client device 1210 (which may also be referred to as “client system” herein) includes one or more of the following: one or more processors 1212; one or more memory devices 1214; one or more network interface devices 1216; one or more display interfaces 1218; and one or more user input adapters 1220. Additionally, in some embodiments, the client device 1210 is connected to or includes a display device 1222. As will explained below, these elements (e.g., the processors 1212, memory devices 1214, network interface devices 1216, display interfaces 1218, user input adapters 1220, display device 1222) are hardware devices (for example, electronic circuits or combinations of circuits) that are configured to perform various different functions for the computing device 1210.

In some embodiments, each or any of the processors 1212 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1212 uses an instruction set architecture such as x86 or Advanced RISC Machine (ARM).

In some embodiments, each or any of the memory devices 1214 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1212). Memory devices 1214 are examples of non-volatile computer-readable storage media.

In some embodiments, each or any of the network interface devices 1216 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, each or any of the display interfaces 1218 is or includes one or more circuits that receive data from the processors 1212, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 1222, which displays the image data. Alternatively or additionally, in some embodiments, each or any of the display interfaces 1218 is or includes, for example, a video card, video adapter, or graphics processing unit (GPU).

In some embodiments, each or any of the user input adapters 1220 is or includes one or more circuits that receive and process user input data from one or more user input devices (not shown in FIG. 7) that are included in, attached to, or otherwise in communication with the client device 1210, and that output data based on the received input data to the processors 1212. Alternatively or additionally, in some embodiments each or any of the user input adapters 1220 is or includes, for example, a PS/2 interface, a USB interface, a touchscreen controller, or the like; and/or the user input adapters 1220 facilitates input from user input devices (not shown in FIG. 7) such as, for example, a keyboard, mouse, trackpad, touchscreen, etc. . . . .

In some embodiments, the display device 1222 may be a Liquid Crystal Display (LCD) display, Light Emitting Diode (LED) display, or other type of display device. In embodiments where the display device 1222 is a component of the client device 1210 (e.g., the computing device and the display device are included in a unified housing), the display device 1222 may be a touchscreen display or non-touchscreen display. In embodiments where the display device 1222 is connected to the client device 1210 (e.g., is external to the client device 1210 and communicates with the client device 1210 via a wire and/or via wireless communication technology), the display device 1222 is, for example, an external monitor, projector, television, display screen, etc. . . . .

In various embodiments, the client device 1210 includes one, or two, or three, four, or more of each or any of the above-mentioned elements (e.g., the processors 1212, memory devices 1214, network interface devices 1216, display interfaces 1218, and user input adapters 1220). Alternatively or additionally, in some embodiments, the client device 1210 includes one or more of: a processing system that includes the processors 1212; a memory or storage system that includes the memory devices 1214; and a network interface system that includes the network interface devices 1216.

The client device 1210 may be arranged, in various embodiments, in many different ways. As just one example, the client device 1210 may be arranged such that the processors 1212 include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip). As another example, the client device 1210 may be arranged such that: the processors 1212 include two, three, four, five, or more multi-core processors; the network interface devices 1216 include a first network interface device that implements Ethernet and a second network interface device that implements WiFi and/or Bluetooth; and the memory devices 1214 include a RAM and a flash memory or hard disk.

Server system 1200 also comprises various hardware components used to implement the software elements for server system 220 of FIG. 2 an. In some embodiments, the server system 1200 (which may also be referred to as “server device” herein) includes one or more of the following: one or more processors 1202; one or more memory devices 1204; and one or more network interface devices 1206. As will explained below, these elements (e.g., the processors 1202, memory devices 1204, network interface devices 1206) are hardware devices (for example, electronic circuits or combinations of circuits) that are configured to perform various different functions for the server system 1200.

In some embodiments, each or any of the processors 1202 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1202 uses an instruction set architecture such as x86 or Advanced RISC Machine (ARM).

In some embodiments, each or any of the memory devices 1204 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1202). Memory devices 1204 are examples of non-volatile computer-readable storage media.

In some embodiments, each or any of the network interface devices 1206 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In various embodiments, the server system 1200 includes one, or two, or three, four, or more of each or any of the above-mentioned elements (e.g., the processors 1202, memory devices 1204, network interface devices 1206). Alternatively or additionally, in some embodiments, the server system 1200 includes one or more of: a processing system that includes the processors 1202; a memory or storage system that includes the memory devices 1204; and a network interface system that includes the network interface devices 1206.

The server system 1200 may be arranged, in various embodiments, in many different ways. As just one example, the server system 1200 may be arranged such that the processors 1202 include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip). As another example, the server system 1200 may be arranged such that: the processors 1202 include two, three, four, five, or more multi-core processors; the network interface devices 1206 include a first network interface device that implements Ethernet and a second network interface device that implements WiFi and/or Bluetooth; and the memory devices 1204 include a RAM and a flash memory or hard disk.

As previously noted, whenever it is described in this document that a software module or software process performs any action, the action is in actuality performed by underlying hardware elements according to the instructions that comprise the software module. Consistent with the foregoing, in various embodiments, each or any combination of the client device 210 or the server system 220, each of which will be referred to individually for clarity as a “component” for the remainder of this paragraph, are implemented using an example of the client device 1210 or the server system 1200 of FIG. 7. In such embodiments, the following applies for each component: (a) the elements of the client device 1210 shown in FIG. 7 (i.e., the one or more processors 1212, one or more memory devices 1214, one or more network interface devices 1216, one or more display interfaces 1218, and one or more user input adapters 1220) and the elements of the server system 1200 (i.e., the one or more processors 1202, one or more memory devices 1204, one or more network interface devices 1206), or appropriate combinations or subsets of the foregoing, are configured to, adapted to, and/or programmed to implement each or any combination of the actions, activities, or features described herein as performed by the component and/or by any software modules described herein as included within the component; (b) alternatively or additionally, to the extent it is described herein that one or more software modules exist within the component, in some embodiments, such software modules (as well as any data described herein as handled and/or used by the software modules) are stored in the respective memory devices (e.g., in various embodiments, in a volatile memory device such as a RAM or an instruction register and/or in a non-volatile memory device such as a flash memory or hard disk) and all actions described herein as performed by the software modules are performed by the respective processors in conjunction with, as appropriate, the other elements in and/or connected to the client device 1210 or server system 1200; (c) alternatively or additionally, to the extent it is described herein that the component processes and/or otherwise handles data, in some embodiments, such data is stored in the respective memory devices (e.g., in some embodiments, in a volatile memory device such as a RAM and/or in a non-volatile memory device such as a flash memory or hard disk) and/or is processed/handled by the respective processors in conjunction, as appropriate, the other elements in and/or connected to the client device 1210 or server system 1200; (d) alternatively or additionally, in some embodiments, the respective memory devices store instructions that, when executed by the respective processors, cause the processors to perform, in conjunction with, as appropriate, the other elements in and/or connected to the client device 1210 or server system 1200, each or any combination of actions described herein as performed by the component and/or by any software modules described herein as included within the component.

The hardware configurations shown in FIG. 7 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 7, (e) via other hardware arrangements, architectures, and configurations, and/or via combinations of the technology described in (a) through (e).

### Technical Advantages of Described Subject Matter

The technology described herein allows for efficient storage and processing of order data and improves the system's ability to display information and interact with a user. In particular, the system can process large volumes of order data elements and efficiently store the same in a database managed by the system so that the data can be used to generate the user interface. In doing so, the system efficiently stores, organizes, and manages large volumes of data by breaking the data down into understandable components that are used in fast and efficient generation of a display presenting the data.

The resultant user interface generated by the system thus provides information in an easy-to-view manner. In particular, the user interface provides a graphical display of order data showing a relationship between parent order(s) and child order(s). The user interface allows the user to manipulate the display by selecting an individual parent order so that the associated child orders may be highlighted. The graphical user interface thus presents the order data in a manner that is significantly easier to understand and access than viewing the order data itself. Moreover, the graphical user interface provides a specific manner for displaying order information resulting in an improved user interface. Thus, the technology also provides improvements in the technical area of software user interfaces and generates an interface that improves the system's ability to interact with the user.

### Selected Definitions

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

### Further Applications of Described Subject Matter

Although a number of references are made in this document to web applications, it should be understood that the features described herein may also be used, in various embodiments, in the context of other types of applications such as applications that are deployed/installed as binaries on client systems.

Although a number of references are made in this document to the trading of “securities” and “security instruments,” it should be understood that the features described herein may be used with respect to any type of asset or instrument that can be traded in any kind of market, including without limitation all types of securities (equities, derivatives, options, etc.), futures, fiat currencies, crypto-assets (including cryptocurrencies and tokens).

Although process steps, algorithms or the like, including without limitation with reference to FIGS. 1-7, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A system configured to generate a user interface conveying order data, comprising:
a back end server having at least one memory and at least one processor operatively coupled to the memory, the back end server configured to perform operations that include:
receiving order data that includes one or more records, wherein each record is associated with an order for a tradeable instrument;
parsing the order data, wherein the parsing includes:
based on a given record from the one or more records including a parent flag element, identifying the order that corresponds to the given record as a parent order, wherein the parent order has an order identifier; and
based on a given record from the one or more records including a parent order identifier element that indicates the order identifier of the parent order, identifying the order that corresponds to the given record as a child order from a plurality of child orders of the parent order;
storing information that describes the plurality of child orders and the parent order to a structured data store that is stored in the memory, wherein the structured data store links the plurality of child orders to the parent order based on the order identifier of the parent order; and
a client device having at least one memory and at least one processor, the client device configured to communicate with the back end server using communication circuitry, the client device further configured to perform operations that include:
generating a user interface that includes a graph;
determining positions on the graph for displaying a plurality of child order objects, wherein each of the child order objects corresponds to activity in a respective one of the plurality of child orders;
determining, based on the determined positions for displaying the plurality of child order objects, a position on the graph for displaying a parent order object, wherein the parent order object corresponds to activity in the parent order; and
displaying the graph with the plurality of child order objects at the positions determined for displaying the plurality of child order objects and with the parent order object at the determined position for displaying the parent order object.

2. The system of claim 1, wherein the back end server is further configured to perform operations that include:
filtering on the plurality of child orders by identifying child orders associated with a parent order based on a corresponding parent order identifier; and
building a list of child orders using the corresponding parent order identifier, and filtering the child orders using the assembled list.

3. The system of claim 1, wherein each of the records for the child orders includes a parent order identifier and an order identifier, and wherein the record for the identified parent order does not include a parent order identifier.

4. The system of claim 1, wherein multiple records in the order data have the same order identifier.

5. The system of claim 1, wherein the client device is further configured to perform operations that include:
processing a selection of a first parent order object that is displayed as part of the generated user interface; and
in response to selection of the first parent order object, filtering the populated child order objects based on the selected first parent order object.

6. The system of claim 5, wherein the child order objects are filtered by removing child order objects from the user interface that are not linked with the selected parent order object.

7. The system of claim 1, wherein the client device is further configured to perform operations that include:
when the parent order object is selected, displaying in the user interface an overlay window containing details of the parent order and the child orders.

8. A method for generating a user interface conveying order data, the method comprising:
at an information processing system having at least a processor and a memory:
communicating with a server to receive data for generating a user interface associated with one or more tradeable instruments, the received data including child order data and parent order data, the child order data for a plurality of child orders that each reference a corresponding parent order referenced in the parent order data;
generating, for display on a display device that is coupled to the information processing system, the user interface having a graph, wherein time is represented along a first axis of the graph and value is represented along a second axis of the graph;
determining positions on the graph for one or more child order objects that each reflect activity in an individual child order of the plurality of child orders associated with the one or more tradeable instruments;
determining positions on the graph for one or more parent order objects based on the determined positions of the one or more child order objects, the one or more parent order objects associated with one of the corresponding parent orders included in the parent order data; and
populating the graph with the child order objects and the parent order objects at their respective determined positions; and
displaying the graph, with the one or more child order objects displayed in a first format and the one or more parent order objects displayed in a second format that is different from the first format.

9. The method of claim 8, further comprising:
receiving a selection of a parent order object;
filtering the child order objects and updating the display of the graph based on the filtering.

10. The method of claim 9, wherein the filtering includes removing, from display, child order objects other than those associated with the selected parent order object.

11. The method of claim 8, further comprising:
selecting a first parent order object that is displayed;
displaying an overlay window containing details of the parent order and the child orders that are associated with the selected first parent order object.

12. The method of claim 8, wherein the determined positions for the one or more parent order objects are along a timeline located at a position above the one or more child order objects along the first axis.

13. The method of claim 8, wherein the one or more parent order objects that are displayed in the second format include an alphanumeric character to distinguish the one or more parent order objects from the one or more child order objects.

14. A server, comprising:
a processor; and
a memory storing computer readable instructions that, when executed by the processor, cause the server to:
obtain order data indicative of one or more orders for a tradeable instrument;
parse the order data to extract one or more elements associated with the one or more orders;
identify orders from the order data that are parent orders based on information included in the one or more extracted elements;
identify orders from the order data as child orders based on information included in the one or more extracted elements;
link child orders to parent orders based on a corresponding child order having a parent order identifier that matches an identifier of a corresponding parent order; and
store the linked child orders and parent orders in the memory.

15. The server of claim 14, wherein the instructions, when executed by the processor, further cause the server to:
access the linked child orders and parent orders in the memory;
generate visualization data from the linked child orders and parent orders; and
transmit the visualization data to one or more client devices.

16. The server of claim 14, wherein the instructions, when executed by the processor, further cause the server to:
determine that an extracted element includes a parent flag, and based on inclusion of the parent flag the order associated with the extracted element is identified as a parent order;
determine that an extracted element includes a parent order identifier, and based on inclusion of the parent order identifier, the order associated with the extracted element is identified as child order;
wherein the child orders are linked to a corresponding parent order based on the parent order identifier.

17. The server of claim 15, wherein one or more child order objects in the visualization data are configured to be filtered from the visualization data based on the parent order identifier.

18. The server of claim 17, the child order objects are filtered by identifying child orders associated with a parent order based on the parent order identifier, building a list of child orders using the parent order identifier, and filtering the child order objects using the assembled list.

19. The server of claim 14, wherein elements associated with child orders contain both a parent order identifier and an order identifier, and elements associated with parent orders contain an order identifier and do not contain a parent order identifier.

20. The server of claim 14, where multiple records in the order data have the same order identifier.
